(19) United States
(12) Patent Application Publication
(10) Pub. No.: US 2011/0304595 A1
(43) Pub. Date: Dec. 15, 2011

(54) DISPLAY

(75) Inventor: Paul HOLMES, Dalgety Bay Fife (GB)

(73) Assignee: Forth Dimension Displays Ltd, Dalgety Bay Fife (GB)

(21) Appl. No.: 13/163,155

(22) Filed: Jun. 17, 2011

Related U.S. Application Data
(63) Continuation of application No. PCT/GB2009/051754, filed on Dec. 21, 2009.

(30) Foreign Application Priority Data
Dec. 19, 2008 (GB) 0823222.5

(51) Int. Cl. G09G 5/00

(52) U.S. Cl. 345/204

(57) ABSTRACT

A control means for a pixel display, for displaying pixel images provided as rows of data to a row driver, includes a shift register for transposing each row of data so that it is written to the row driver in a manner that causes each pixel of the row of data to be translated by a number of pixels distance across the screen, and also includes a fill data means for writing a blank signal to the pixels which the row of data would be written too had it not been translated. A second fill data means is included for writing a blank signal to the pixels on the opposite side of the row of data to the blank pixels written by the first fill data means. The amount which the shift register transposes the rows of data may be varied.

### CROSS REFERENCE TO RELATED APPLICATIONS

This Application is a Continuation of International Application No. PCT/GB2009/051754, filed 21 Dec. 2009, which claims the benefit of GB0823222.5 filed Dec. 19, 2008, the entirety of each of which are hereby incorporated by reference herein.

### FIELD OF THE INVENTION

The invention relates to displays, particularly the showing of different dimension images on pixelated displays such as liquid crystal on silicon displays.

### BACKGROUND

Displays are sometimes required to work at a variety of resolutions. When the display has a variable raster (as a CRT has), this can be achieved by resynchronization, but when the display has a fixed arrays of pixels (e.g. an LCOS display) other techniques must be used.

One such technique is re-sizing. A new set of pixels appropriate for the new display is generated from the original set of pixels. There are many silicon solutions to accomplish this, but resizing often causes sampling artefacts, e.g. “jaggies” on text and diagrams, and also often distorts the image's aspect ratio.

### BRIEF DESCRIPTION OF THE DRAWINGS

FIG. 1 illustrates a display, formats, and margins;

FIG. 2 is a diagram of control word redirection;

FIG. 3 is a diagram of wide and narrow modes;

FIG. 4 illustrates a two-mode centering shifter;

FIG. 5 is a diagram of a flexible centering shifter;

FIG. 6 is a diagram of a flexible centering shifter having five shift units;

FIG. 7A-7B illustrate data being fed to the shift registers;

FIG. 8 illustrates a right fill unit; and

FIG. 9 illustrates switching units of a right fill unit.

### SUMMARY OF THE INVENTION

The present invention provides a windowing method having a good bandwidth efficiency. According to the present invention there is provided a control means for a pixel display, for displaying pixel images provided as rows of data to a row driver, wherein there is included a shift register for transposing each row of data so that it is written to the row driver in a manner that causes each pixel of the row of data to be translated by a number of pixels distance across the screen, and there is included a fill data means for writing a blank signal to the pixels which the row of data would be written too had it not been translated.

### DETAILED DESCRIPTION OF THE INVENTION

If complications due to resynchronization or re-sizing are unacceptable for a given application, then an approach is ‘windowing’. In this approach, the display has sufficient x- and y-resolution to contain every supported format, the original set of pixels is used and each format is shown undistorted on a portion of the display large enough to contain it. Unused portions of the display are referred to as margins, and are typically set to black.

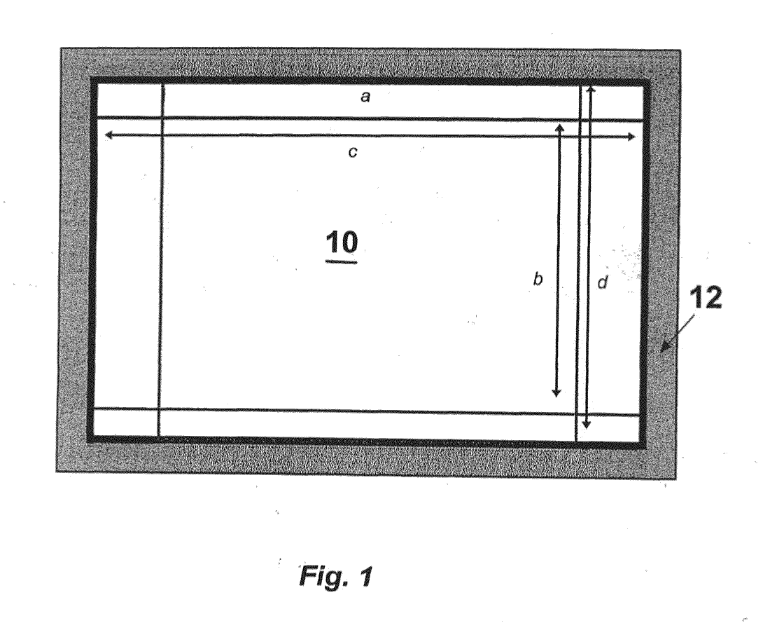

Referring to FIG. 1, a display 10 has a native resolution of 1920 pixels by 1200 pixels. The display is also configured to support an HDTV format of 1920 pixels c by 1080 pixels b (16:9 aspect ratio) and a monitor format of 1600 pixels a by 1200 pixels d (4:3 aspect ratio).

The display may also have a border 12 of e.g. 32 pixels round all four sides. These pixels, if present, cannot receive image data and are architecturally designed to be driven black at all times.

When HDTV format is selected, the unused rows above and below the image are called the top and bottom margins. When monitor format is selected, the unused areas to the left and right of the image are called the side margins.

The display is natively binary. Greyscales are rendered using binary weighted bitplanes. Colour is rendered by a colour sequential technique. Data is loaded row by row, though in other displays, the x- and y- axes could be reversed, without affecting the principle.

Bitplane data is clocked into the display over a 64 bit bus, and each clock cycle on the bus allows a word containing 64 pixels to be loaded (the use of a Double Data Rate (DDR) interface would alter the arithmetic, but the same principles would still apply). To load a complete row (1920 pixels) on the display, 30 such words are required for the pixel data, plus one control word (containing row addresses and other control signals for the display control circuitry), making a total of 31 clock cycles per row.

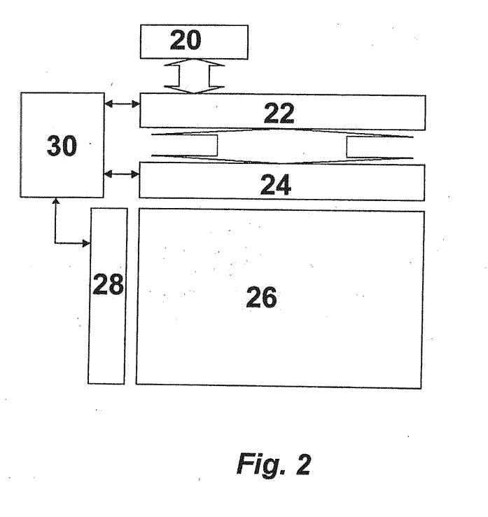

As shown in FIG. 2, a demultiplexer 22 receives the pixel data one 64-bit word at a time from the input port 20, and assembles them into 1920 parallel bits for the column driver 24. Control words are redirected to the display control circuitry 30 which operates the row driver 28. The column and row drivers 24, 28 then drive the display screen 26.

To load an entire bitplane, 1200 rows are transmitted, requiring a total of 31×1200=37200 clock cycles. The number of clock cycles needed is significant because it determines the amount of bandwidth which will be required to support any given combination of bit depth and refresh rate. The bandwidth requirement, in turn, affects the cost of the display and its associated drive electronics.

In HDTV format, only 1080 rows of image data need to be transmitted for each bitplane, requiring 31×1080=33480 clock cycles—a saving of 10%. This is slightly offset by a requirement to initialize the 120 margin rows, but this can be done just once per frame instead of for every bitplane, so when large numbers of bitplanes are used per frame the saving approaches 10%.

Monitor format has an area about 16.7% smaller than the full display, due to the 160-pixel margin on each side of the active image, so ideally a bandwidth saving around 16.7% might be achievable.

The display drive electronics captures the 1600×1200 video signal and centres it in a 1920×1200 framestore, padding the side margins with data to produce an optical black state. Given the addressing method described above, each row must be transmitted completely before the next can begin. This means that 31 words are still needed for each row. Since Monitor Format has no fewer lines than the entire display, when simply addressing the display in this manner, the number of cycles per bitplane is unchanged at 37200.

A new shift register is provided with what will be referred to as ‘wide mode’ and ‘narrow mode’. In wide mode, it operates just as before. In narrow mode, the shift register operates as if it were only 1600 bits wide, and its output is offset by 160 columns so that the image is correctly centred.

The remaining columns are filled with ‘fill data’, which is not transmitted from the drive electronics, but is generated inside the display control circuitry. The fill data would consist either of all zeroes or all ones, whichever corresponds to an optical black state.

In narrow mode, the shift register needs only 25 words of pixel data, plus one control word, making 26 words per row. The saving is 16.1% compared with the ideal of 16.7%.

Other formats can be split into two classes:
less than or equal to 1600 pixels wide (these would use narrow mode), and
more than 1600 pixels wide (these would use wide mode).

Formats up to 1600 pixels wide which don't use the full height of the display can benefit from both bandwidth-saving techniques described above.

Although this display system has a shift register with two hard-wired width modes, in principle, three or more hard-wired width modes could also be implemented, but these are not described here.

Alternatively, a general mechanism could be used to support any number of data words from 1 to 30 (or however many data words are needed for full width), which will be described later.

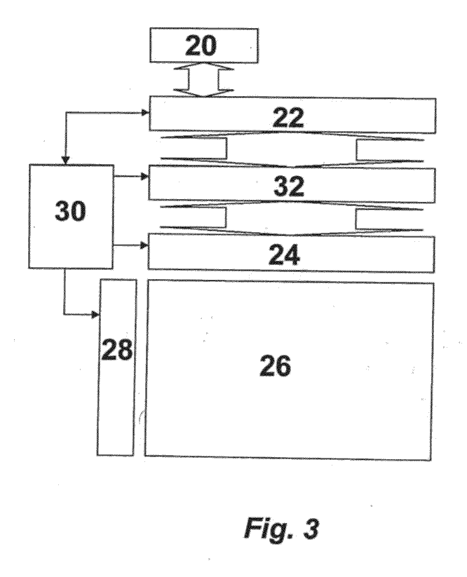

Referring now to FIG. 3, wide and narrow modes are accomplished by the insertion of a centering shifter 32 between the demultiplexer 22 and column driver 24.

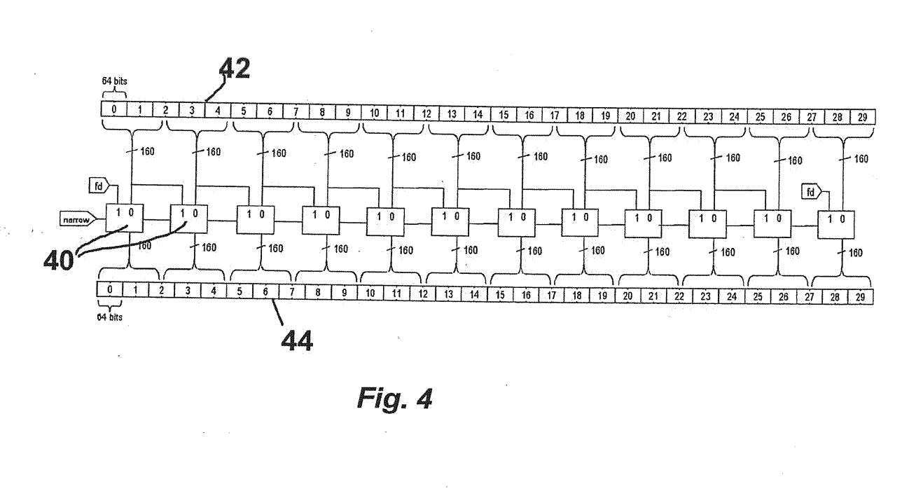

The two-mode centering shifter 24 contains twelve data switches 40, each of which selects one of two 160-bit input busses and routes it to its single 160-bit output bus, as shown in FIG. 4.

When narrow mode is switched off, the ‘narrow’ input line, which controls each of the switches 40, is 0. Each switch selects the bus at its ‘0’ input for routing the input 42 to its output 44. In this way, every one of the 1920 bits coming in from the de-multiplexer 22 is routed to the same line in the output to the column driver 24.

When narrow mode is switched on, the ‘narrow’ input line is 1, and each switch selects the bus at its ‘1’ input for routing to its output. Each bit of the first 1600 bits in the input is shifted to the right by 160 places. The first 160 and last 160 bits in the output are generated from fill data (fd).

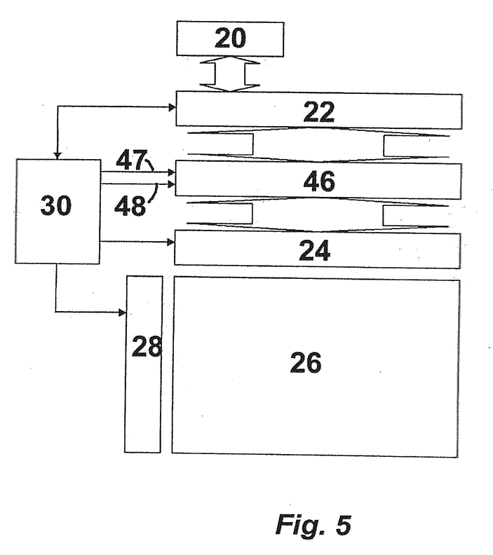

Referring to FIG. 5, a flexible centering shifter, which will accept any number of 64-bit words from 1 to the full device width (in our example, 30 words) rather than accepting just two input widths, may be provided. The active image width is set via a control word, which is interpreted by the control circuitry 30 and used to produce two types of signals called ‘shift enables’ 47 and ‘fill enables’ 48 for the flexible centering shifter 46.

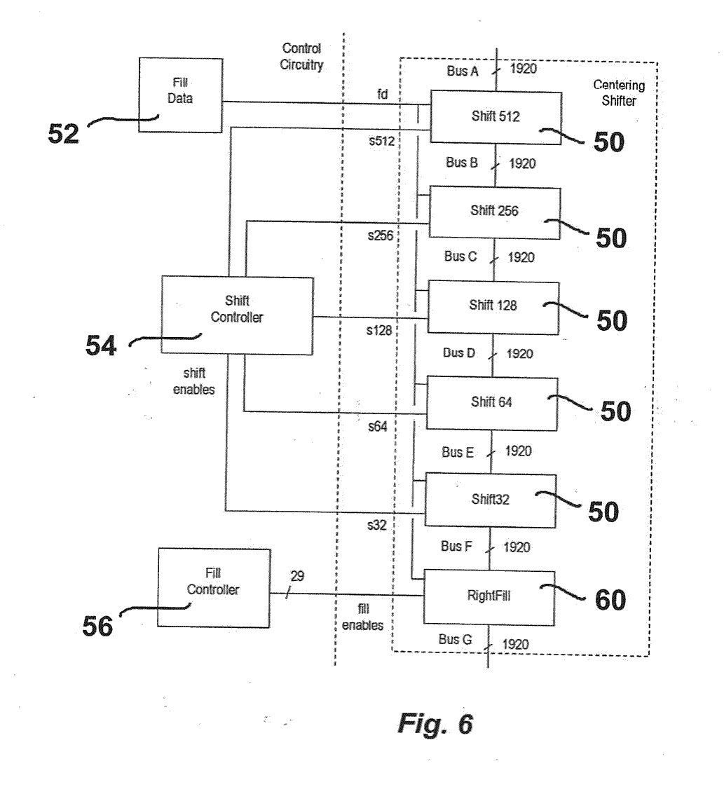

Referring to FIG. 6, the flexible centering shifter contains five shift units 50, named Shift512, Shift256, Shift 128, Shift64 and Shift32. Each of the shift units is similar in structure to the two-mode shifter in FIG. 4, but instead of shifting by 160 bits, they shift by 512, 256, 128, 64 and 32 bits respectively. The control circuitry includes a Fill Data means 52 which adds the necessary amount of data (as a multiple 32 bit) to the relevant shift register or registers to form the left hand margin. The shift controller 54 then activates the necessary shift registers to move the data the required amount to the right. Finally, the Fill Controller 56 instructs a Right Fill means 60 to add the necessary data for a right hand margin.

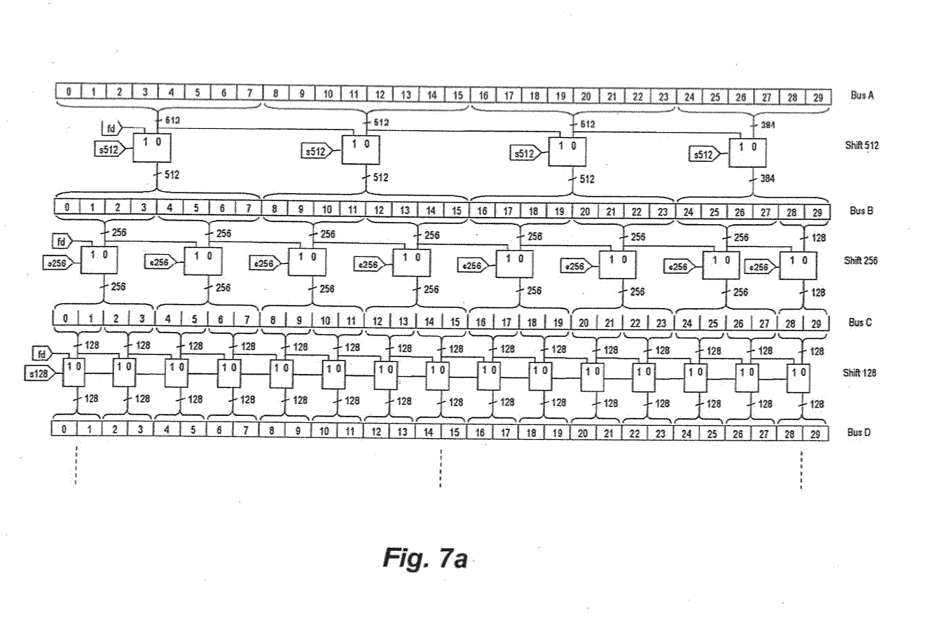

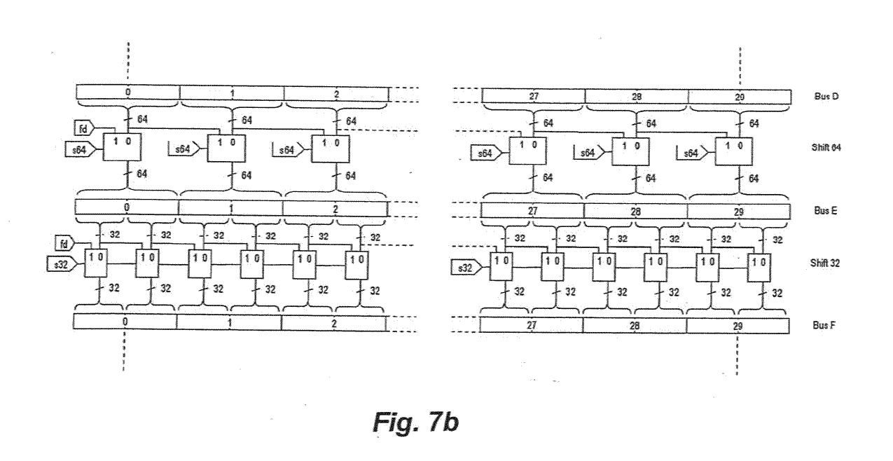

FIG. 7A-7B show data from Bus A being fed to the shift registers Shift512, and output to Bus B, which is in turn input to the shift registers Shift256. Each set of shift registers has buses interposed between then in this way to pass on the data as the amount of shift is added. Thus the shift registers

Shift256 outputs to Bus C, which is read by shift registers Shift128 which outputs to Bus D, which is read by shift registers Shift64 which outputs to Bus E, which is read by shift registers Shift32 which outputs to Bus F.

The five shift enable lines together allow the image to shifted right by any multiple of 32 bits, from 0×32 to 32×32, but in practice the highest value needed is 29×32. The values used for each width of input (as multiples of 32 bits) are shown in Table 1.

TABLE 1

| input | shift | | | | | |
|---|---|---|---|---|---|---|
| words | units | s512 | s256 | s128 | s64 | s32 |
| 1 | 29 | 1 | 1 | 1 | 0 | 1 |
| 2 | 28 | 1 | 1 | 1 | 0 | 0 |
| 3 | 27 | 1 | 1 | 0 | 1 | 1 |
| 4 | 26 | 1 | 1 | 0 | 1 | 0 |
| 5 | 25 | 1 | 1 | 0 | 0 | 1 |
| 6 | 24 | 1 | 1 | 0 | 0 | 0 |
| 7 | 23 | 1 | 0 | 1 | 1 | 1 |
| 8 | 22 | 1 | 0 | 1 | 1 | 0 |
| 9 | 21 | 1 | 0 | 1 | 0 | 1 |
| 10 | 20 | 1 | 0 | 1 | 0 | 0 |
| 11 | 19 | 1 | 0 | 0 | 1 | 1 |
| 12 | 18 | 1 | 0 | 0 | 1 | 0 |
| 13 | 17 | 1 | 0 | 0 | 0 | 1 |
| 14 | 16 | 1 | 0 | 0 | 0 | 0 |
| 15 | 15 | 0 | 1 | 1 | 1 | 1 |
| 16 | 14 | 0 | 1 | 1 | 1 | 0 |
| 17 | 13 | 0 | 1 | 1 | 0 | 1 |
| 18 | 12 | 0 | 1 | 1 | 0 | 0 |
| 19 | 11 | 0 | 1 | 0 | 1 | 1 |
| 20 | 10 | 0 | 1 | 0 | 1 | 0 |
| 21 | 9 | 0 | 1 | 0 | 0 | 1 |
| 22 | 8 | 0 | 1 | 0 | 0 | 0 |
| 23 | 7 | 0 | 0 | 1 | 1 | 1 |
| 24 | 6 | 0 | 0 | 1 | 1 | 0 |
| 25 | 5 | 0 | 0 | 1 | 0 | 1 |
| 26 | 4 | 0 | 0 | 1 | 0 | 0 |
| 27 | 3 | 0 | 0 | 0 | 1 | 1 |
| 28 | 2 | 0 | 0 | 0 | 1 | 0 |
| 29 | 1 | 0 | 0 | 0 | 0 | 1 |
| 30 | 0 | 0 | 0 | 0 | 0 | 0 |

An important feature of this shifter design is that the latency is short and constant—it does not depend upon the amount of shifting which is required. The five shift units (Shift512 to Shift32) ensure by their design that the left margin will be correctly padded with fill data, but the same cannot be said of the right margin. For this reason, a separate right fill unit is incorporated as the final stage in the pipeline.

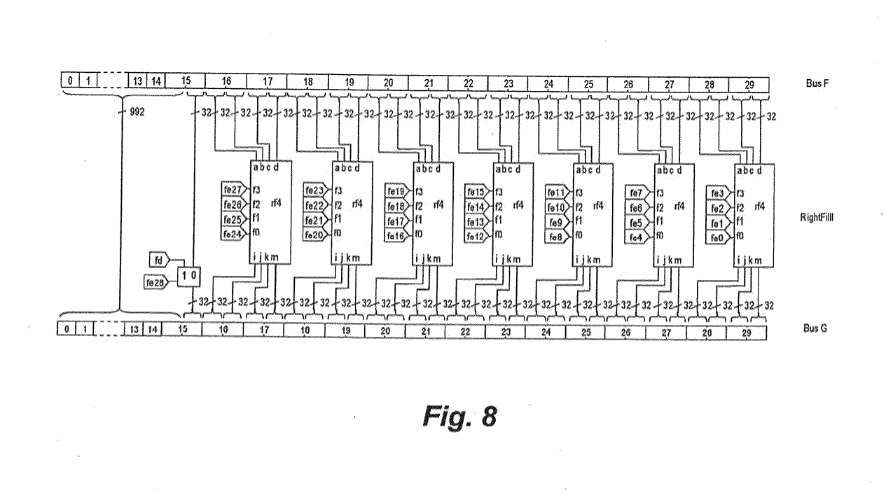

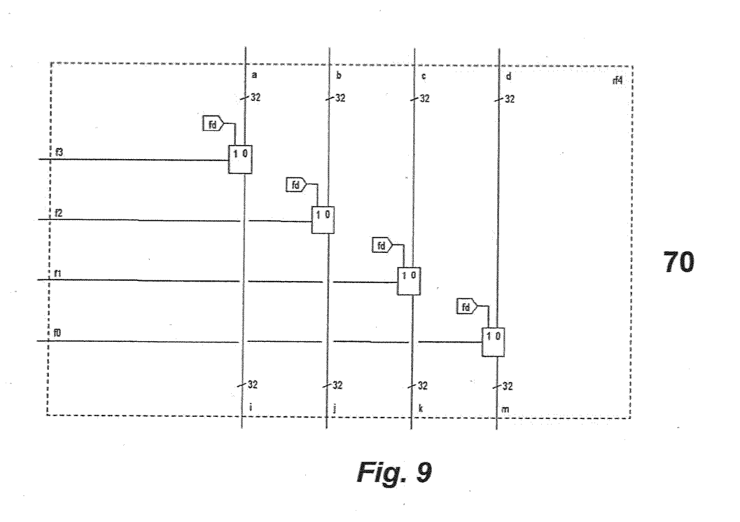

The right fill unit, shown in FIGS. 8 and 9, is controlled by fill enable signals, which are derived by the fill controller as shown in Tables 2 and 3.

TABLE 2
Fill Enable Signals

| | | Right Fill Enable Signals | | | | | | | | | | | | | | | |
|---|---|---|---|---|---|---|---|---|---|---|---|---|---|---|---|---|---|
| | | fe | fe | fe | fe | fe | fe | fe | fe | fe | fe | fe | fe | fe | fe | fe | fe |
| | | 28 | 27 | 26 | 25 | 24 | 23 | 22 | 21 | 20 | 19 | 18 | 17 | 16 | 15 | 14 | 13 |
| number | 1 | 1 | 1 | 1 | 1 | 1 | 1 | 1 | 1 | 1 | 1 | 1 | 1 | 1 | 1 | 1 | 1 |
| of | 2 | 0 | 1 | 1 | 1 | 1 | 1 | 1 | 1 | 1 | 1 | 1 | 1 | 1 | 1 | 1 | 1 |
| words | 3 | 0 | 0 | 1 | 1 | 1 | 1 | 1 | 1 | 1 | 1 | 1 | 1 | 1 | 1 | 1 | 1 |
| in | 4 | 0 | 0 | 0 | 1 | 1 | 1 | 1 | 1 | 1 | 1 | 1 | 1 | 1 | 1 | 1 | 1 |
| use | 5 | 0 | 0 | 0 | 0 | 1 | 1 | 1 | 1 | 1 | 1 | 1 | 1 | 1 | 1 | 1 | 1 |
| | 6 | 0 | 0 | 0 | 0 | 0 | 1 | 1 | 1 | 1 | 1 | 1 | 1 | 1 | 1 | 1 | 1 |
| | 7 | 0 | 0 | 0 | 0 | 0 | 0 | 1 | 1 | 1 | 1 | 1 | 1 | 1 | 1 | 1 | 1 |
| | 8 | 0 | 0 | 0 | 0 | 0 | 0 | 0 | 1 | 1 | 1 | 1 | 1 | 1 | 1 | 1 | 1 |
| | 9 | 0 | 0 | 0 | 0 | 0 | 0 | 0 | 0 | 1 | 1 | 1 | 1 | 1 | 1 | 1 | 1 |
| | 10 | 0 | 0 | 0 | 0 | 0 | 0 | 0 | 0 | 0 | 1 | 1 | 1 | 1 | 1 | 1 | 1 |
| | 11 | 0 | 0 | 0 | 0 | 0 | 0 | 0 | 0 | 0 | 0 | 1 | 1 | 1 | 1 | 1 | 1 |
| | 12 | 0 | 0 | 0 | 0 | 0 | 0 | 0 | 0 | 0 | 0 | 0 | 1 | 1 | 1 | 1 | 1 |
| | 13 | 0 | 0 | 0 | 0 | 0 | 0 | 0 | 0 | 0 | 0 | 0 | 0 | 1 | 1 | 1 | 1 |
| | 14 | 0 | 0 | 0 | 0 | 0 | 0 | 0 | 0 | 0 | 0 | 0 | 0 | 0 | 1 | 1 | 1 |
| | 15 | 0 | 0 | 0 | 0 | 0 | 0 | 0 | 0 | 0 | 0 | 0 | 0 | 0 | 0 | 1 | 1 |
| | 16 | 0 | 0 | 0 | 0 | 0 | 0 | 0 | 0 | 0 | 0 | 0 | 0 | 0 | 0 | 0 | 1 |
| | 17 | 0 | 0 | 0 | 0 | 0 | 0 | 0 | 0 | 0 | 0 | 0 | 0 | 0 | 0 | 0 | 0 |
| | 18 | 0 | 0 | 0 | 0 | 0 | 0 | 0 | 0 | 0 | 0 | 0 | 0 | 0 | 0 | 0 | 0 |
| | 19 | 0 | 0 | 0 | 0 | 0 | 0 | 0 | 0 | 0 | 0 | 0 | 0 | 0 | 0 | 0 | 0 |
| | 20 | 0 | 0 | 0 | 0 | 0 | 0 | 0 | 0 | 0 | 0 | 0 | 0 | 0 | 0 | 0 | 0 |
| | 21 | 0 | 0 | 0 | 0 | 0 | 0 | 0 | 0 | 0 | 0 | 0 | 0 | 0 | 0 | 0 | 0 |
| | 22 | 0 | 0 | 0 | 0 | 0 | 0 | 0 | 0 | 0 | 0 | 0 | 0 | 0 | 0 | 0 | 0 |
| | 23 | 0 | 0 | 0 | 0 | 0 | 0 | 0 | 0 | 0 | 0 | 0 | 0 | 0 | 0 | 0 | 0 |
| | 24 | 0 | 0 | 0 | 0 | 0 | 0 | 0 | 0 | 0 | 0 | 0 | 0 | 0 | 0 | 0 | 0 |
| | 25 | 0 | 0 | 0 | 0 | 0 | 0 | 0 | 0 | 0 | 0 | 0 | 0 | 0 | 0 | 0 | 0 |
| | 26 | 0 | 0 | 0 | 0 | 0 | 0 | 0 | 0 | 0 | 0 | 0 | 0 | 0 | 0 | 0 | 0 |
| | 27 | 0 | 0 | 0 | 0 | 0 | 0 | 0 | 0 | 0 | 0 | 0 | 0 | 0 | 0 | 0 | 0 |
| | 28 | 0 | 0 | 0 | 0 | 0 | 0 | 0 | 0 | 0 | 0 | 0 | 0 | 0 | 0 | 0 | 0 |
| | 29 | 0 | 0 | 0 | 0 | 0 | 0 | 0 | 0 | 0 | 0 | 0 | 0 | 0 | 0 | 0 | 0 |
| | 30 | 0 | 0 | 0 | 0 | 0 | 0 | 0 | 0 | 0 | 0 | 0 | 0 | 0 | 0 | 0 | 0 |

| | | Right Fill Enable Signals | | | | | | | | | | | | |
|---|---|---|---|---|---|---|---|---|---|---|---|---|---|---|
| | | fe | fe | fe | fe | fe | fe | fe | fe | fe | fe | fe | fe | fe |
| | | 12 | 11 | 10 | 9 | 8 | 7 | 6 | 5 | 4 | 3 | 2 | 1 | 0 |
| number | 1 | 1 | 1 | 1 | 1 | 1 | 1 | 1 | 1 | 1 | 1 | 1 | 1 | 1 |
| of | 2 | 1 | 1 | 1 | 1 | 1 | 1 | 1 | 1 | 1 | 1 | 1 | 1 | 1 |
| words | 3 | 1 | 1 | 1 | 1 | 1 | 1 | 1 | 1 | 1 | 1 | 1 | 1 | 1 |
| in | 4 | 1 | 1 | 1 | 1 | 1 | 1 | 1 | 1 | 1 | 1 | 1 | 1 | 1 |
| use | 5 | 1 | 1 | 1 | 1 | 1 | 1 | 1 | 1 | 1 | 1 | 1 | 1 | 1 |
| | 6 | 1 | 1 | 1 | 1 | 1 | 1 | 1 | 1 | 1 | 1 | 1 | 1 | 1 |
| | 7 | 1 | 1 | 1 | 1 | 1 | 1 | 1 | 1 | 1 | 1 | 1 | 1 | 1 |
| | 8 | 1 | 1 | 1 | 1 | 1 | 1 | 1 | 1 | 1 | 1 | 1 | 1 | 1 |
| | 9 | 1 | 1 | 1 | 1 | 1 | 1 | 1 | 1 | 1 | 1 | 1 | 1 | 1 |
| | 10 | 1 | 1 | 1 | 1 | 1 | 1 | 1 | 1 | 1 | 1 | 1 | 1 | 1 |
| | 11 | 1 | 1 | 1 | 1 | 1 | 1 | 1 | 1 | 1 | 1 | 1 | 1 | 1 |
| | 12 | 1 | 1 | 1 | 1 | 1 | 1 | 1 | 1 | 1 | 1 | 1 | 1 | 1 |
| | 13 | 1 | 1 | 1 | 1 | 1 | 1 | 1 | 1 | 1 | 1 | 1 | 1 | 1 |
| | 14 | 1 | 1 | 1 | 1 | 1 | 1 | 1 | 1 | 1 | 1 | 1 | 1 | 1 |
| | 15 | 1 | 1 | 1 | 1 | 1 | 1 | 1 | 1 | 1 | 1 | 1 | 1 | 1 |
| | 16 | 1 | 1 | 1 | 1 | 1 | 1 | 1 | 1 | 1 | 1 | 1 | 1 | 1 |
| | 17 | 1 | 1 | 1 | 1 | 1 | 1 | 1 | 1 | 1 | 1 | 1 | 1 | 1 |
| | 18 | 0 | 1 | 1 | 1 | 1 | 1 | 1 | 1 | 1 | 1 | 1 | 1 | 1 |
| | 19 | 0 | 0 | 1 | 1 | 1 | 1 | 1 | 1 | 1 | 1 | 1 | 1 | 1 |
| | 20 | 0 | 0 | 0 | 1 | 1 | 1 | 1 | 1 | 1 | 1 | 1 | 1 | 1 |
| | 21 | 0 | 0 | 0 | 0 | 1 | 1 | 1 | 1 | 1 | 1 | 1 | 1 | 1 |
| | 22 | 0 | 0 | 0 | 0 | 0 | 1 | 1 | 1 | 1 | 1 | 1 | 1 | 1 |
| | 23 | 0 | 0 | 0 | 0 | 0 | 0 | 1 | 1 | 1 | 1 | 1 | 1 | 1 |
| | 24 | 0 | 0 | 0 | 0 | 0 | 0 | 0 | 1 | 1 | 1 | 1 | 1 | 1 |
| | 25 | 0 | 0 | 0 | 0 | 0 | 0 | 0 | 0 | 1 | 1 | 1 | 1 | 1 |
| | 26 | 0 | 0 | 0 | 0 | 0 | 0 | 0 | 0 | 0 | 1 | 1 | 1 | 1 |
| | 27 | 0 | 0 | 0 | 0 | 0 | 0 | 0 | 0 | 0 | 0 | 1 | 1 | 1 |
| | 28 | 0 | 0 | 0 | 0 | 0 | 0 | 0 | 0 | 0 | 0 | 0 | 1 | 1 |
| | 29 | 0 | 0 | 0 | 0 | 0 | 0 | 0 | 0 | 0 | 0 | 0 | 0 | 1 |
| | 30 | 0 | 0 | 0 | 0 | 0 | 0 | 0 | 0 | 0 | 0 | 0 | 0 | 0 |

Each Right Fill means rf4 are interposed between Bus F and Bus G, each the Right Fill means rf4 either copying the data from Bus F to Bus G or producing a signal for the right margin on Bus G, depending on the Fill Enable fe0 to fe28 signals determined by the data in Table 2 which control the Right Fill means rf4. More specifically, referring to FIG. 9, each Right Fill means 70 includes 4 switching units each having a 32 bit input a,b,c,d and a fill data input fd. Each switching means is operated by control signals f0, f1, f2, f3. If a control signal is 0, the switching unit copies the 32 bit word from to its respective output i, j, k, m. If the control signal is 0, the switching unit copies the dark signal provided by fill data input fd.

This five-shifter architecture would be suitable, with minor modifications, for any display width up to 2048 pixels. The addition of a sixth shifter would support displays up to 4096 pixels wide, and each additional shifter thereafter would further double the maximum image width. Although the example structure has assumed a 64-bit input bus, it is easily adapted to other input bus widths.

1. A control means for a pixel display, for displaying pixel images provided as rows of data to a row driver, wherein there is included a shift register for transposing each row of data so that it is written to the row driver in a manner that causes each pixel of the row of data to be translated by a number of pixels distance across the screen, and there is included a fill data means for writing a blank signal to the pixels which the row of data would be written too had it not been translated.

2. A control means according to claim 1 wherein a second fill data means is included for writing a blank signal to the pixels on the opposite side of the row of data to the blank pixels written by the first fill data means.

3. A control means according to claim 1, wherein amount which the shift register transposes the rows of data may be varied.

4. A control means according to claim 2, wherein amount which the shift register transposes the rows of data may be varied.
